(19) United States
(12) Patent Application Publication
(10) Pub. No.: US 2011/0136691 A1
(43) Pub. Date: Jun. 9, 2011

(54) GOLD-SILVER ALLOY NANOPARTICLE CHIP, METHOD OF FABRICATING THE SAME AND METHOD OF DETECTING MICROORGANISMS USING THE SAME

(75) Inventors: Wan Joong KIM, Goyang (KR); Bong Kyu Kim, Daejeon (KR); Gun Yong Sung, Daejeon (KR); Chul Huh, Daejeon (KR); Hyun Sung Ko, Seoul (KR); Jong Cheol Hong, Daejeon (KR); Kyung Hyun Kim, Daejeon (KR); Chil Seong Ah, Daejeon (KR)

(73) Assignee: Electronics and Telecommunications Research Institute, Daejeon (KR)

(21) Appl. No.: 12/878,362

(22) Filed: Sep. 9, 2010

(30) Foreign Application Priority Data
Dec. 4, 2009 (KR) 10-2009-0119665

(51) Int. Cl. C40B 30/10; C40B 40/18; C40B 50/14

(52) U.S. Cl. 506/12; 506/22; 506/30; 977/773

(57) ABSTRACT

Provided are a gold-silver alloy nanoparticle chip, a method of fabricating the same and a method of detecting microorganisms using the same. The gold-silver alloy nanoparticle chip includes a hydrophilized glass substrate, a self-assembled monolayer formed on the glass substrate, and gold-silver alloy nanoparticles fixed on the self-assembled monolayer. The gold-silver alloy nanoparticle chip having such a structure enables microorganisms in a water purifier and tap water to be readily detected and enables detection efficiency to be enhanced.

### CROSS-REFERENCE TO RELATED APPLICATION

This application claims priority to and the benefit of Korean Patent Application No. 10-2009-0119665, filed Dec. 4, 2009, the disclosure of which is incorporated herein by reference in its entirety.

### BACKGROUND

1. Field of the Invention

The present invention relates to a gold-silver alloy nanoparticle chip, a method of fabricating the same and a method of detecting microorganisms using the same. More particularly, the present invention relates to a method of optically detecting microorganisms using a chip fabricated by fixing gold-silver alloy nanoparticles on a glass surface.

2. Discussion of Related Art

Pollution of tap water and water from a water purifier caused by microorganisms is a significant problem. Therefore, in order to remove pollution caused by microorganisms in water we drink, a technique of placing charcoal or silver nanoparticles into a water purifier filter to filter the water has been intensively studied. Also, recognizing a degree of pollution of water from a water purifier filter or tap water is also important.

Conventionally, experience of a measurer had a great effect on measuring the level of pollution caused by microorganisms. Therefore, in general, the level of microbiologic pollution was measured through turbidity of a fluid.

Measuring the level of microbiologic pollution through turbidity of a fluid may be very subjective, and different measurements may be shown depending on measurers, so that the accuracy thereof may be significantly lowered. In order to overcome such problems, and to meet demand for developing a technique of quantitatively measuring the concentration of microorganisms, various techniques have been developed.

The techniques include a method in which conductivity is changed according to a degree of microorganisms attached to a surface of stainless steel used therein. That is, the number of microorganisms attached to the surface of the stainless steel is proportional to the conductivity, and thus the conductivity is measured to infer the concentration of the microorganisms.

However, such devices have a complicated constitution, and measuring the level of pollution of a water purifier filter or other pollution therewith may not be easy. Therefore, development of a sensor capable of easily measuring the concentration of microorganisms is required.

During current research into a method to overcome the problems of the conventional art, the following was observed. Gold-silver alloy nanoparticles may be readily attached to the thiol group of cysteine on a surface of a microorganism, and thus when gold-silver alloy nanoparticles are fixed on a glass substrate to form a chip, microorganisms may be optically and easily detected, and thus the present invention was completed.

### SUMMARY OF THE INVENTION

The present invention is directed to a gold-silver alloy nanoparticle chip capable of easily and optically detecting microorganisms.

The present invention is also directed to a method of fabricating a gold-silver alloy nanoparticle chip capable of easily and optically detecting microorganisms.

The present invention is further directed to a method of easily and optically detecting microorganisms from a gold-silver alloy nanoparticle chip.

An aspect of the present invention provides a gold-silver alloy nanoparticle chip including: a hydrophilized glass substrate; a self-assembled monolayer formed on the glass substrate; and gold-silver alloy nanoparticles fixed on the self-assembled monolayer.

The hydrophilized glass substrate may have a surface on which a hydroxyl group is introduced, and the self-assembled monolayer may be a silane self-assembled monolayer that has an amine group.

500 to 1000 of the gold-silver alloy nanoparticles may be fixed on the glass substrate per 1 μm².

Another aspect of the present invention provides a method of fabricating a gold-silver alloy nanoparticle chip including: hydrophilizing a glass substrate; forming a self-assembled monolayer on the hydrophilized glass substrate; and fixing gold-silver alloy nanoparticles on the self-assembled monolayer.

The hydrophilizing of the glass substrate may include introducing a hydroxyl group on a surface of the glass substrate, introducing a hydroxyl group may include immersing the glass substrate in a piranha solution (H₂SO₄:H₂O₂=7:3), and drying the substrate using an inert gas, and introducing a hydroxyl group may be performed by processing the surface of the glass substrate using oxygen plasma.

The self-assembled monolayer may be a silane self-assembled monolayer having an amine group and may be formed by contacting a mixture of 3-aminopropyltriethoxysilane (APTES) and ethanol with the hydrophilized glass substrate. The self-assembled monolayer may be fixed on the glass substrate through an annealing process.

The gold-silver alloy nanoparticles may be fixed on the self-assembled monolayer through a surface chemical reaction.

Still another aspect of the present invention provides a method of detecting microorganisms including: hydrophilizing a glass substrate; forming a self-assembled monolayer on the hydrophilized glass substrate; fixing gold-silver alloy nanoparticles on the self-assembled monolayer; contacting the gold-silver alloy nanoparticle chip with target microorganisms; and optically measuring presence of the target microorganisms.

The target microorganisms may be E. coli.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a cross-sectional view of a gold-silver alloy nanoparticle chip according to one exemplary embodiment of the present invention;

FIG. 2 is a flowchart illustrating a process of fabricating a gold-silver alloy nanoparticle chip according to one exemplary embodiment of the present invention;

FIG. 3 is a schematic diagram illustrating a process of detecting microorganisms using a gold-silver alloy nanoparticle chip according to one exemplary embodiment of the present invention;

FIG. 4 is a scanning electron microscope image of a surface of a gold-silver alloy nanoparticle chip fabricated according to one exemplary embodiment of the present invention;

FIGS. 5A to 5D are graphs illustrating optical measurement results according to the concentration of E. coli measured using a gold-silver alloy nanoparticle chip fabricated according to one exemplary embodiment of the present invention;

FIG. 6 is a graph illustrating a change in wavelength according to the concentration of E. coli using a gold-silver alloy nanoparticle chip fabricated according to one exemplary embodiment of the present invention;

FIGS. 7A and 7B are graphs illustrating a change in wavelength over time using a gold-silver alloy nanoparticle chip fabricated according to one exemplary embodiment of the present invention; and

FIG. 8 is a scanning electron microscope image of E. coli captured in a gold-silver alloy nanoparticle chip fabricated according to one exemplary embodiment of the present invention.

### DETAILED DESCRIPTION OF EXEMPLARY EMBODIMENTS

The present invention will be described more fully hereinafter with reference to the accompanying drawings, in which exemplary embodiments of the invention are shown. This invention may, however, be embodied in different forms and should not be construed as limited to the embodiments set forth herein. In the following description of the present invention, a detailed description of known functions and components incorporated herein will be omitted when it may make the subject matter of the present invention rather unclear.

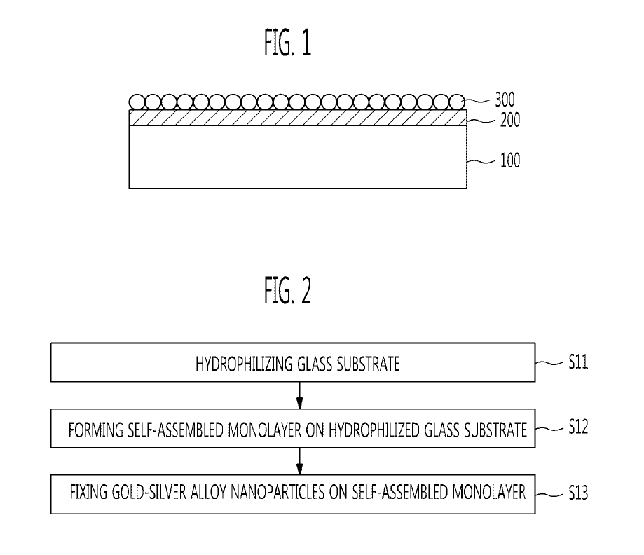

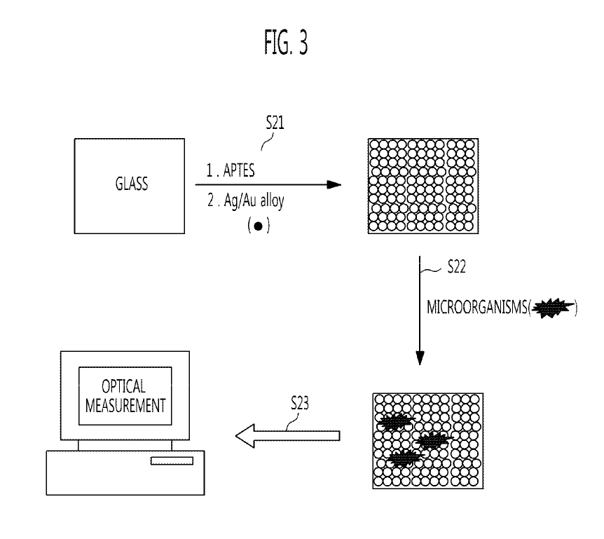

FIG. 1 is a cross-sectional view of a gold-silver alloy nanoparticle chip according to one exemplary embodiment of the present invention, and FIG. 2 is a flowchart illustrating a process of fabricating a gold-silver nanoparticle chip according to one exemplary embodiment of the present invention.

Referring to FIG. 1, a gold-silver alloy nanoparticle chip according to the present invention includes a hydrophilized glass substrate 100, a self-assembled monolayer 200 formed on the glass substrate 100, and gold-silver alloy nanoparticles 300 fixed on the self-assembled monolayer 200.

Referring to FIG. 2, a method of fabricating a gold-silver alloy nanoparticle chip includes hydrophilizing a glass substrate 100 (S11), forming a self-assembled monolayer 200 on the hydrophilized glass substrate 100 (S12) and fixing the gold-silver alloy nanoparticles 300 on the self-assembled monolayer 200 (S13).

A gold-silver alloy nanoparticle chip and a method of fabricating the same will be described below with reference to the combination of FIGS. 1 and 2.

Hydrophilizing the glass substrate 100 (S11) includes introducing a hydroxyl group on the glass substrate 100.

The method of introducing a hydroxyl group includes immersing the glass substrate 100 in a piranha solution (H₂SO₄:H₂O₂=7:3), and drying the results using an inert gas. Here, the glass substrate may be immersed within a range of 5 minutes to 20 minutes, and after the immersion, the substrate may be cleansed several times using distilled water, and dried using an inert gas such as nitrogen. After being dried using an inert gas, the substrate may be dried again at a temperature of 100° C. to 120° C. for 30 minutes to one hour.

A second method of introducing a hydroxyl group includes performing an oxygen plasma process on a surface of the glass substrate 100. The oxygen plasma process may be performed on the surface of the glass substrate 100 for about 100 seconds to 5 minutes using oxygen plasma.

In forming the self-assembled monolayer 200 on the hydrophilized glass substrate 100 (S12), a mixture of 3-aminopropyltriethoxysilane (APTES) and ethanol is placed on the surface of the hydrophilized glass substrate on which a hydroxyl group has been introduced, and the results are left as they are for 10 minutes to one hour, so that the self-assembled monolayer 200 is formed. Afterwards, the results are cleansed several times using ethanol, and then an annealing process may be performed on the results at a temperature of 100° C. to 150° C. for 5 minutes to 30 minutes such that the self-assembled monolayer is strongly fixed on the substrate.

Then, in order to confirm the formation of the self-assembled monolayer, the thickness of the self-assembled monolayer where amine is formed is confirmed using ellipsometry. The self-assembled monolayer may be formed to a thickness of 0.5 nm to 0.7 nm.

In fixing the gold-silver alloy nanoparticles 300 on the self-assembled monolayer 200 (S13), the glass substrate on which the self-assembled monolayer is formed is immersed in a gold-silver alloy nanoparticle dispersion solution to be left for 10 to 14 hours. During this process, the gold-silver particles are fixed on the surface of the self-assembled monolayer as a result of a surface chemical reaction. Then, the results are cleansed several times using water, and dried using an inert gas such as nitrogen. Here, trivalent gold (e.g., HAuCl₄) and univalent silver (e.g., AgNO₃) molecule are reduced to be zero-valent using a reducing agent (e.g., sodium citrate), so that gold-silver alloy nanoparticles are formed. The formed gold-silver alloy nanoparticles may be formed to a size of 13 nm to 20 nm.

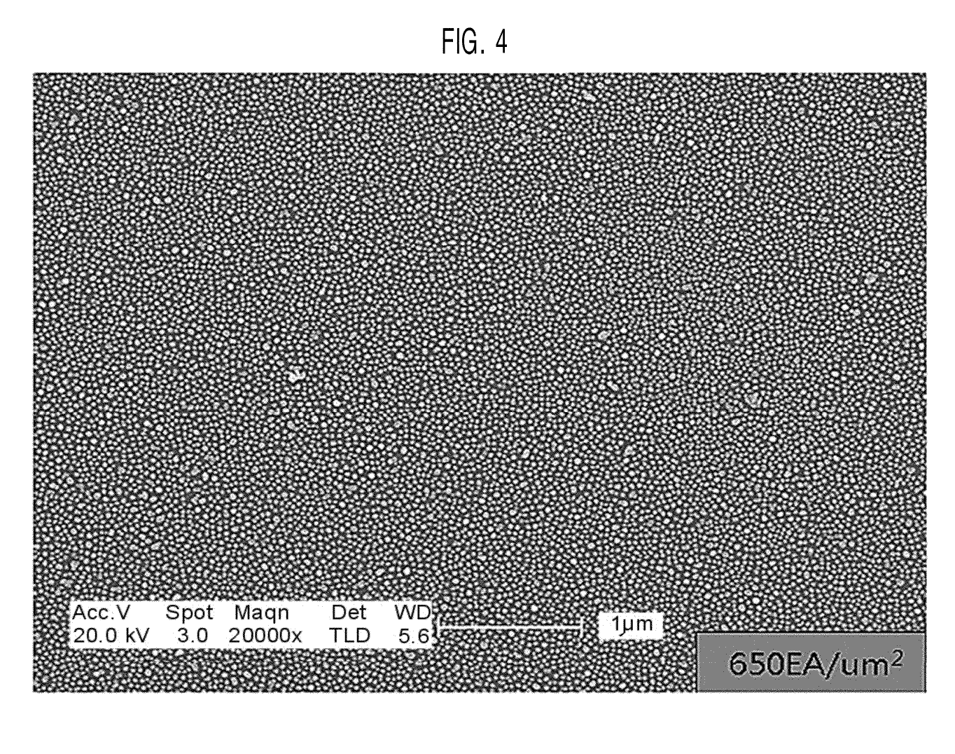

FIG. 3 is a schematic diagram illustrating a process of detecting microorganisms using a gold-silver alloy nanoparticle chip according to one exemplary embodiment of the present invention.

Referring to FIG. 3, a glass substrate is hydrophilized, a self-assembled monolayer is formed on the hydrophilized glass substrate, and gold-silver alloy nanoparticles are fixed on the self-assembled monolayer, so that a gold-silver alloy nanoparticle chip is fabricated (S21), the gold-silver alloy nanoparticle chip is in contact with target microorganisms (S22), and the presence of the target microorganisms is optically measured (S23).

Fabrication of the gold-silver alloy nanoparticle chip (S21) is the same as that described with reference to FIG. 2.

Then, contacting the gold-silver alloy nanoparticle chip with the target microorganisms (S22) may include immersing the gold-silver alloy nanoparticle chip in a solution in which the target microorganisms are mixed, and alternatively, the gold-silver alloy nanoparticle chip may be in contact with the target microorganisms using an ordinary method in this field.

Afterwards, in optically measuring the presence of the target microorganisms (S23), an optical measurement device, e.g., a UV spectrophotometer, is used to measure microorganisms and to confirm whether microorganisms are captured or not, and furthermore, to measure the concentration of the microorganisms.

In this case, E. coli may be detected as the target microorganisms. That is, the thiol group of cysteine in E, coli is combined with the gold-silver alloy nanoparticles, so that the presence of E. coli may be detected.

Therefore, the gold-silver alloy nanoparticle chip may be readily used to detect presence of microorganisms in a water purifier or tap water.

### EXAMPLE

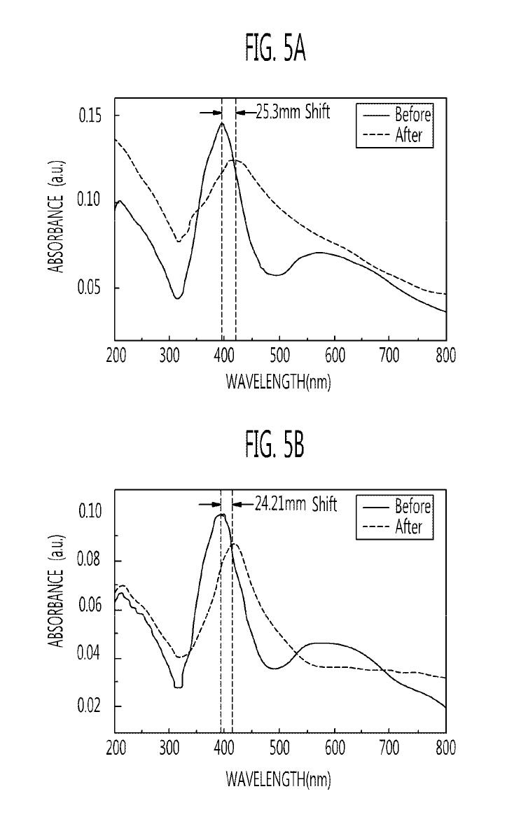

A glass substrate was immersed in a piranha solution (H₂SO₄:H₂O₂=7:3) for 10 minutes, cleansed several times using distilled water, gradually dried using an inert gas such as nitrogen, and dried again at a temperature of 100° C. for 30 minutes, so that an —OH group was formed on a surface of the glass substrate. Then, in order to form a self-assembled monolayer, 10 ml of ethanol was mixed with 0.1 ml of 0.1% APTES, and the mixture was placed on the surface of the glass substrate where the —OH group was formed for 30 minutes. Afterwards, the results were cleansed several times using ethanol, and were annealed at a temperature of 120° C. for 10 minutes to further strengthen the coupling to the glass substrate, so that a silane self-assembled monolayer (SAM) was formed. Then, in order to confirm whether the reaction was made or not, the thickness of the SAMs where amine (—NH₂) was formed was confirmed using ellipsometry. The SAM was formed to a thickness of 0.6 nm. Subsequently, the glass substrate on which the SAM was formed was immersed in 10 ml of a 0.4 nM aqueous solution of the gold-silver alloy nanoparticles fabricated by reducing HAuCl₄ and AgNO₃ in the same mole with sodium citrate to be left at room temperature for 12 hours. Then, the results were cleansed several times using water and gradually dried using nitrogen, so that a chip in which the gold-silver alloy nanoparticles were fixed on the glass substrate was fabricated. The fabricated chip was scanned with a scanning electron microscope, and the scanned results are shown in FIG. 4. Also, as a result of confirming the surface of the fabricated chip using field emission-scanning electron microscopy (FE-SEM), it was observed that about 650 gold-silver alloy nanoparticles were fixed on the glass substrate per 1 μm².

### Experimental Example 1

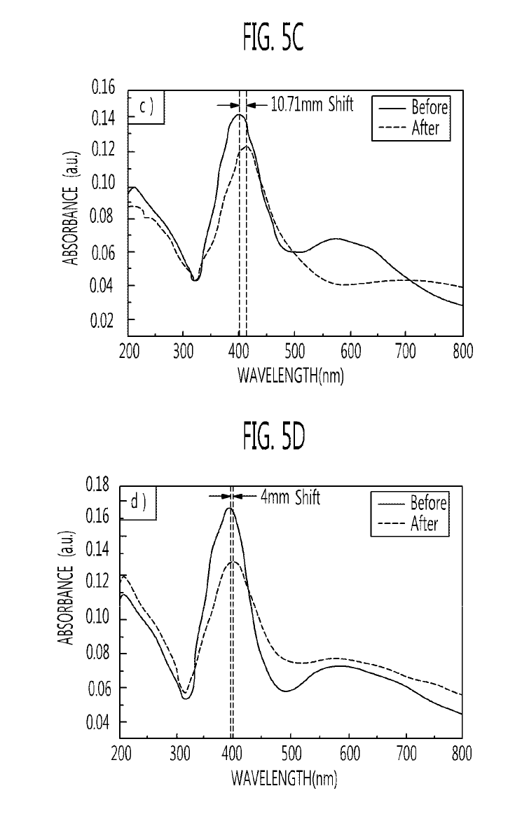

After the gold-silver alloy nanoparticle chip fabricated in the example was immersed in water containing E. coli whose concentration was a) 4E7 EA/ml, b) 4E5 EA/ml, c) 4E3 EA/ml and d) 4E2 EA/ml, respectively, for 48 hours, the results were optically measured, and the measured results are shown in the following Table 1, and FIGS. 5A to 5D.

TABLE 1

| | | b) | c) | d) |
|---|---|---|---|---|
| | a) 4E7 EA/ml | 4E5 EA/ml | 4E3 EA/ml | 4E2 EA/ml |
| Shift of | 25.3 nm | 24.2 nm | 10 nm | 4 nm |
| Absorbance | | | | |

Referring to Table 1 and FIG. 5, it was observed that the shift of the absorbance increased in proportion to the concentration of E. coli.

### Experimental Example 2

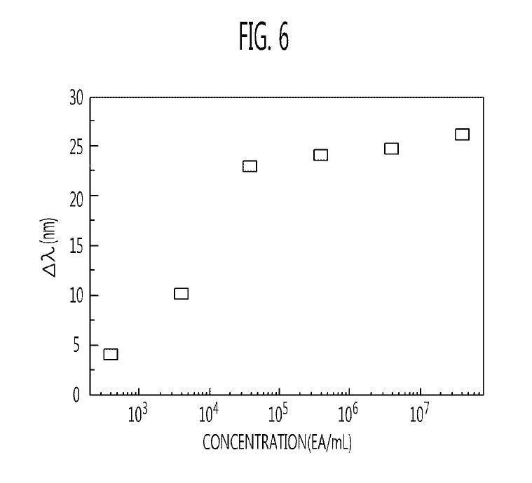

After the gold-silver alloy nanoparticle chip fabricated in the example was immersed in water containing E. coli whose concentration was 4E7 EA/ml, 4E6 EA/ml, 4E5 EA/ml, 4E4 EA/ml, 4E3 EA/ml, and 4E2 EA/ml, respectively, for 48 hours, a change in wavelength was measured, and the measured results are shown in FIG. 6.

Referring to FIG. 6, it was observed that the change in wavelength increased in proportion to the concentration of E. coli.

### Experimental Example 3

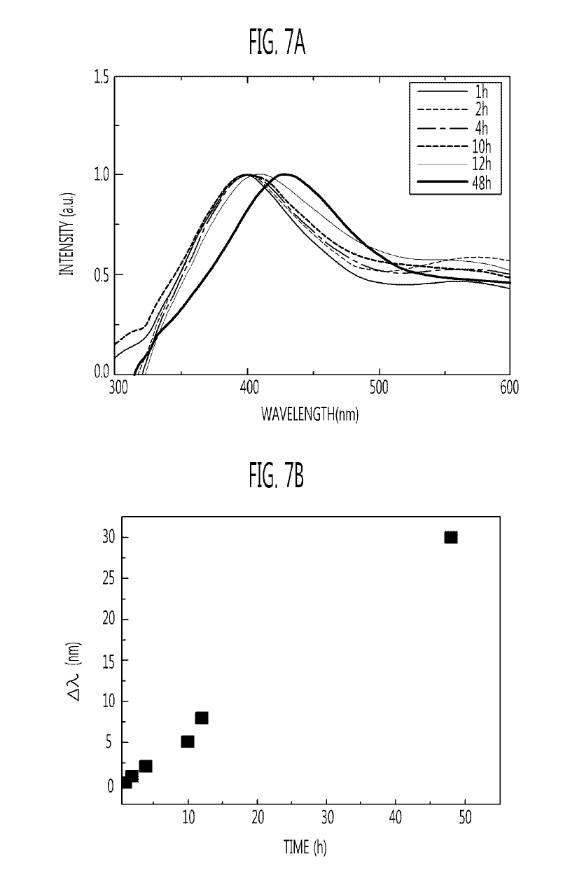

After the gold-silver alloy nanoparticle chip fabricated in the example was immersed in water containing E. coli whose concentration was 4E3 EA/ml for 1 hour, 2 hours, 4 hours, 10 hours, 12 hours and 48 hours, respectively, a change in wavelength over time was measured, and the measured results are shown in FIGS. 7A and 7B.

Referring to FIG. 7B, it was observed that in E, coli whose concentration was 4E3 EA/ml, a wavelength was changed as great as 0 nm, 1 nm, 2 nm, 5 nm, 8 nm, and 30 nm for 1 hour, 2 hours, 4 hours, 10 hours, 12 hours and 48 hours, respectively.

### Experimental Example 4

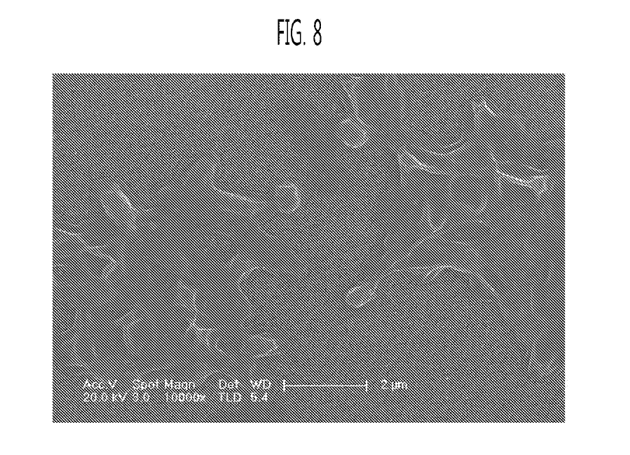

After the gold-silver alloy nanoparticle chip fabricated in the example was immersed in water containing E. coli whose concentration was 4E3 EA/ml for one hour, the surface of the gold-silver alloy nanoparticle chip was scanned by a scanning electron microscope, and the scanned results are shown in FIG. 8.

As described above, a method of detecting target microorganisms using a gold-silver alloy nanoparticle chip fabricated by fixing gold-silver alloy nanoparticles according to the present invention on a glass substrate can enable microorganisms in a water purifier or tap water to be easily detected, and detection efficiency to be improved.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A gold-silver alloy nanoparticle chip for detecting microorganisms, comprising:
a hydrophilized glass substrate;
a self-assembled monolayer formed on the glass substrate; and
gold-silver alloy nanoparticles fixed on the self-assembled monolayer.

2. The chip of claim 1, wherein the hydrophilized glass substrate has a surface on which a hydroxyl group is introduced.

3. The chip of claim 1, wherein the self-assembled monolayer is a silane self-assembled monolayer that has an amine group.

4. The chip of claim 1, wherein 500 to 1000 of the gold-silver alloy nanoparticles are fixed on the glass substrate per 1 μm².

5. A method of fabricating a gold-silver alloy nanoparticle chip, comprising:
hydrophilizing a glass substrate;
forming a self-assembled monolayer on the hydrophilized glass substrate; and
fixing gold-silver alloy nanoparticles on the self-assembled monolayer.

6. The method of claim 5, wherein hydrophilizing the glass substrate comprises introducing a hydroxyl group on a surface of the glass substrate.

7. The method of claim 6, wherein introducing the hydroxyl group comprises immersing the glass substrate in a piranha solution (H₂SO₄:H₂O₂=7:3), and drying the substrate using an inert gas.

8. The method of claim 6, wherein introducing the hydroxyl group is performed by treating the surface of the glass substrate using oxygen plasma.

9. The method of claim 5, wherein the self-assembled monolayer is formed by contacting a mixture of 3-aminopropyltriethoxysilane (APTES) and ethanol with the hydrophilized glass substrate.

10. The method of claim 5, wherein the self-assembled monolayer formed on the glass substrate is strengthened through an annealing process.

11. The method of claim 5, wherein the gold-silver alloy nanoparticles are fixed on the self-assembled monolayer through a surface chemical reaction.

12. A method of detecting microorganisms, comprising:
fabricating a gold-silver alloy nanoparticle chip according to any of claim 1;
contacting the gold-silver alloy nanoparticle chip with target microorganisms; and
optically measuring presence of the target microorganisms.

13. The method of claim 12, wherein the target microorganisms are E. coli.
